(19) United States
(12) Patent Application Publication
(10) Pub. No.: US 2005/0183632 A1
(43) Pub. Date: Aug. 25, 2005

(54) Lightweight cast stone composition and method

(76) Inventor: Daryl Joseph Sturre, Bluffton, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/057,315

(22) Filed: Feb. 11, 2005

Related U.S. Application Data
(60) Provisional application No. 60/543,809, filed on Feb. 11, 2004.

(51) Int. Cl. C08H 1/00; C04B 7/00; E04H 1/00

(52) U.S. Cl. 106/122; 428/304.4; 106/638

(57) ABSTRACT

A moldable cast stone composition for use in making lightweight decorative features for attachment to an interior or exterior surface includes: (a) from about 30 to about 65% of foam beads having an average diameter of between about 1/32 and about ⅛ inch; (b) from about 10 to about 25% of a cementitious material; (c) from about 5 to about 20% of a Portland cement; (d) from about 5 to about 15% of an acrylic bonding primer; and (e) the balance being water. A method of making lightweight cast stone decorative features is also included.

### CROSS REFERENCE TO RELATED DOCUMENT

Benefit is claimed under 35 USC 119(e) of provisional U.S. patent application No. 60/543,809, filed on Feb. 11, 2004.

### BACKGROUND OF THE INVENTION

1. Technical Field

The present invention relates to a lightweight, moldable cast stone composition for making decorative features for attachment to hard surfaces, such as walls on the exterior or interior of buildings, and a method for making lightweight, moldable cast stone products using the cast stone composition.

2. Background Information

Architects and builders often wish to add decorative features to the exteriors or interiors of houses and other types of buildings that they design and build. However, conventional concrete and other such products are so heavy that they are unsuitable for such applications much of the time. Exterior decorative features, such as window heads, window sills, hand rails, wall caps, pier caps, columns, water table details, key stones, and newell posts, must be fairly lightweight in order to be successfully attached to the exterior surfaces of residences or other buildings long term.

Also, the exterior feature must be made of a material that is sufficiently durable to withstand outdoor conditions, such as adverse weather. The exterior feature material should also be attractive and unlikely to discolor over time, as conventionally made exterior features have a tendency to turn yellow or gray after months or years of exposure to the sun and weather.

Only a few materials suitable for fabricating lightweight, decorative shapes are readily available on the market, specifically blocks of aerated concrete and foam. Unfortunately, these materials have significant downfalls. Aerated concrete blocks must be milled or sculpted into shape before they can be used for exterior decoration. It is convenient to mold decorative features on a job site, where the prospective location for the decorative feature can be seen and dimensions are readily available. Also, foam can be flammable, which is an obviously undesirable characteristic for a construction material, and may cause the job to be uninsurable. Thus, there is a need for a fire-retardant cast stone composition for use in making lightweight decorative features for attachment to the exterior or interior surfaces of buildings or the like, and a method for making durable, yet lightweight, fire-retardant decorative products using this cast stone composition.

### BRIEF SUMMARY OF THE INVENTION

The present invention is a moldable cast stone composition from which surprisingly lightweight exterior decorative features, or products, can be fashioned. This lightweight cast stone material is fire-retardant and durable. Decorative features made according to the present invention are attractive and unlikely to discolor over time. The cast stone composition of the present invention is light in color, and is easy to color to match specifications. Cast stone decorative features according to the present invention are also easy to cut with hand tools.

Since they are much lighter in weight than currently available decorative products, much less labor is required to transport and install them on a job site. For example, a decorative feature made according to the present composition can be moved and installed by a single worker. Since they weigh less than a decorative feature made from a conventional formula, decorative features of the present invention can be made longer or larger and still be easy to lift and install. The durable cast stone products made according to the present invention have a density of between about 27 and about 40, more preferably between about 28 and about 30, pounds per cubic foot (lbs/ft³).

The cast stone composition of the present invention is made using dry and wet ingredients. The “dry” ingredients include: foam beads having an average diameter of between about 1/32 and about ⅛ inch, most preferably about 1/16 inch; cementitious material, preferably a stucco mix with oval and linear fiberglass fibers; and Portland cement. The “wet” ingredients herein are acrylic bonding primer and water. The cast stone composition herein preferably further includes a colorant.

Also included herein is a method for making a lightweight cast stone decorative feature, which includes:
(a) mixing from about 30 to about 65%, most preferably from about 50 to about 60%, of foam beads having an average diameter of between about 1/32 and about ⅛ inch, most preferably about 1/16 inch; from about 10 to about 25, most preferably from about 10 to about 15%, of cementitious material, preferably stucco mix comprising oval and linear fiberglass fibers; from about 5 to about 20%, preferably from about 5 to about 10%, of Portland cement; and from zero to about 15%, preferably from about 2 to about 10%, of fiberglass fiber in a mixer to form a dry mixture;
(b) mixing from about 5 to about 15%, most preferably from about 5 to about 10%, of an acrylic bonding primer, and water to bring the balance to 100%, into the dry mixture to form a wet mixture; and
(c) turning the wet mixture out of the mixer into at least one mold, and allowing the wet mixture to dry and cure to form the lightweight cast stone decorative feature. From about 5 to about 50% of water is preferably added with or after the addition of the acrylic bonding primer.

This method is easy to perform or on a job site, where the location for the decorative feature and its dimensions are readily accessible, or in a plant. Also, lightweight, light colored custom features can easily be created using the present cast stone composition and method.

Step (c) preferably further includes:
(i) turning the wet mixture out of the mixer into at least one mold;
(ii) allowing the wet mixture to cure in the mold or molds for at least about 12 hours, forming the lightweight cast stone product;
(iii) removing the lightweight cast stone product from the mold or molds; and
(iv) allowing the lightweight cast stone product to cure, preferably for at least one week. The method of making the lightweight cast stone product preferably includes mixing a colorant into the present composition.

### DETAILED DESCRIPTION OF THE INVENTION

The present invention is a lightweight cast stone composition for use in making decorative features, sometimes called architectural details, such as hand rails, wall caps, pier caps, window sills, window heads, key stones, water table details, newell posts, fireplace mantels, and range hood surrounds, and various cosmetic fixtures, for attachment to an exterior surface, such as an outside wall of a building, or interior surface, such as a fireplace. The lightweight cast stone composition of the present invention includes foam beads, cementitious material, Portland cement, an acrylic bonding primer, and water.

With respect to the first dry ingredient, the cast stone composition of the present invention comprises from about 30 to about 65%, preferably from about 50 to about 60%, of foam beads. It has been found herein that these foam beads are advantageous for use instead of conventionally used sand in that they help to produce a decorative feature that is extra-light in weight (i.e., it is lighter than decorative features produced by currently available formulas). Decorative features made according to the present invention are easily attached to a hard surface, such as the exterior or interior surfaces of a home.

The foam beads used herein are preferably Permalite foam beads, which are small, generally spherical foam beads. Permalite foam beads are commonly poured into the empty cells within the concrete blocks used to build residential walls in order to help insulate the residence. Foam beads for use herein have an average diameter of between about 1/32 and about ⅛ inch, though miscellaneous smaller or larger diameter foam beads may be present in this ingredient. Beads of this size have been found herein to be easily bound by the wet ingredients of the formula, yet they do not show up as lumps on the surface of any decorative feature made from the composition. If the decorative feature is accidentally knocked against a hard surface, or vice versa, foam beads of this size do not mar the surface of the feature as they might if they were a larger size. A smaller size is a powder that has been found not to mix well in the formula. A highly preferred average diameter of about 1/16 inch has been found herein to perform extremely well. It mixes well and provides a pleasing appearance.

With respect to the second dry ingredient, the cast stone composition of the present invention comprises from about 10 to about 25%, preferably from about 10 to about 15%, of cementitious material, preferably a stucco mix with fiberglass fibers. The stucco mix preferred for use herein includes both oval and linear fiberglass fibers, preferably in a ratio of between about 1:6 and 6:1. These fiberglass fibers contribute strength to decorative features formed from the present cast stone composition.

The cementitous material may be about the same amount of mortar, in which case fiberglass fiber is also added to the present composition for strength. The cast stone composition of the present invention preferably comprises up to about 15% preferably between about 2 and about 10%, of fiberglass fiber (fourth ingredient). Here, the fiberglass fibers are linear shaped. Preferred fiberglass fibers are roughly one inch long on average and very thin (less than about a millimeter thick). The fiberglass fibers are preferably shaken into the cast stone composition as it is added to the mixer with the dry ingredients of the formula for more even distribution and a better outcome. Mortar and fiberglass fibers are especially useful in the present composition for color control where colorant will be added to derive a colored decorative feature. It is therefore not difficult to match color specifications from an interior decorator or architect, for example. Colorant is added to either match or contrast with the interior or exterior surface where the decorative feature will be applied.

With respect to the third dry ingredient, the cast stone composition of the present invention comprises from about 5 to about 20% of Portland cement, preferably from about 5 to about 10% of white Portland cement. The Portland cement contributes strength to decorative features formed from the present cast stone composition. Portland cement is available in a handful of types, any of which could be used herein. The term “white Portland cement” is intended herein to encompass off-white cements too, including the less preferred Portland type 1 gray cement. Although it is less preferred, white calcium aluminate cement may be utilized in place of or with the Portland cement in the present composition.

The first “wet” ingredient in the cast stone composition of the present invention is from about 5 to about 15%, most preferably from about 5 to about 10%, of an acrylic bonding primer. The acrylic bonding primer hardens as it dries.

Lastly, potable water is added to balance the formula and form the mixture into a viscous yet pourable material. The present composition preferably includes from about 5 to about 50% of water. No other ingredients are necessary for making the lightweight cast stone composition herein, although optional ingredients may be added.

A preferred sixth ingredient herein is from about 0.2 to about 2% of any suitable colorant, preferably a powdered pigment. The colorant is preferably mixed into the composition as a final ingredient to provide a visible gauge for determining when the cast stone composition is thoroughly mixed.

Also included herein is a method for making a viscous lightweight cast stone composition as described herein. The steps of the present method are as follows:
(a) mixing from about 30 to about 65%, most preferably from about 50 to about 60% of foam beads having an average diameter of between about 1/32 and about ⅛ inch, most preferably about 1/16 inch; from about 10 to about 25%, most preferably from about 10 to about 15%, of cementitious material, preferably stucco mix comprising oval and linear fiberglass fibers; from about 5 to about 20% of Portland cement, preferably from about 5 to about 10% of white Portland cement; and from zero to about 15%, preferably from about 2 to about 10%, of fiberglass fiber in a mixer to form a dry mixture;
(b) mixing from about 5 to about 15%, most preferably from about 5 to about 10%, of an acrylic bonding primer, and water to bring the balance to 100%, preferably from about 5 to about 50% of water, into the dry mixture to form a wet mixture; and
(c) turning the wet mixture out of the mixer into at least one mold, and allowing the wet mixture to dry and cure to form the lightweight cast stone decorative feature. Percentages herein are on a volume by volume (v/v) basis.

Production of a batch of the lightweight cast stone product is preferably done in three steps. The first step comprises thoroughly mixing the dry ingredients in a conventional mortar mixer or other suitable mixer to form a dry mixture. The dry ingredients are: foam beads, cementitious material (preferably stucco mix), Portland cement, and fiberglass fiber, as described above. Table I lists representative amounts of each dry ingredient per batch.

The second step in the present method includes adding the acrylic bonding primer, which is a wet ingredient, to the mixer, and quickly and thoroughly mixing the primer into the dry mixture to form a wet mixture. The mixture need not be heated during mixing. The second wet ingredient, water, is added to the mixer with or after the acrylic bonding primer. Colorant is optionally added to the mixer. The mixture is thoroughly mixed to form the lightweight cast stone composition. Table II lists representative amounts of each wet ingredient per batch.

TABLE I

| Dry ingredient | Amount/batch |
|---|---|
| Foam beads | 14 gallons, or 12 pounds |
| Stucco mix | 3.5 gallons, or 28 pounds |
| White Portland cement | 2 gallons, or 16.5 pounds |
| Fiberglass fiber | 6 pints, or 0.5 pounds |

TABLE II

| Wet ingredient | Amount/batch |
|---|---|
| Acrylic bonding primer | 1.8 gallons |
| Water | 3 gallons |

Lastly, the lightweight cast stone mixture is emptied into at least one mold sprayed with a releasing agent, allowing the composition to cure in the mold for at least 12 hours, and preferably between about 24 and about 48 hours. The lightweight cast stone product is then removed from the mold, and allowed to cure in the air, preferably for at least one week, and preferably two. For best results, mixing and curing should be done with an ambient temperature of more than about 50 degrees Fahrenheit (and up to about 98 degrees F.). The density of the lightweight cast stone composition is believed to decrease as the mixture air cures. The density of the cured lightweight cast stone decorative features is preferably between about 27 and about 40, more preferably between about 28 and about 30, pounds per cubic foot (lbs/ft³). Decorative features of the present invention weigh between about 25 and about 35, most preferably about 30, pounds per square foot. The rigidity of the cured cast stone product is preferably augmented by dropping several pieces of fiberglass rebar into the cast stone composition in the mold(s) before it hardens. The cured lightweight cast stone composition is easily formed into different, decorative articles, or features.

The natural color of the lightweight cast stone composition of the present invention, and product made from the composition, is a desirable off-white, white, or grayish white. Product made from the composition does not tend to discolor over time. Product from the present composition may be made any color, though, by mixing a colorant into the dry mixture during the first step, or into the wet mixture during the third step. Preferably, from about 0.2 to about 2% of any suitable colorant is mixed into the composition. Although the decorative feature may be painted or coated, as by spraying or brushing a suitable coating material on the feature once it is formed, it is not necessary to coat or paint the decorative feature in order for it to be used on a building or other structure. The cured cast stone product is easily attached to a variety of surfaces using counter sunk screws, or by adhering the feature using zinc lath or mortar, for example.

Cast stone decorative features according to the present invention are also easy to cut with hand tools, such as a hand saw or router. In contrast, an expensive, bulky wet saw is needed to cut conventional decorative features. A miter saw or skill saw can be used to cut the decorative features of the present invention; a wet saw is unnecessary.

The mold may be made from any suitable material, such as fiberglass, wood, or metal. Preferably, the mold is a fiberglass mold, or a foam mold that is laser cut with the desired pattern. For custom designs, a block foam with the negative of the desired design laser cut into it can be inserted into the mold prior to pouring in the present composition. The block foam is sized to fit the mold. After drying, the feature is removed from the mold and the block foam is removed. The mold may have any size and shape desired. Suitable mold cavity shapes include hand rails, window heads, window sills, wall caps, pier caps, water table details, key stones, fireplace mantels/surrounds, range hood surrounds, and balustrades for false balconies. The mold is preferably sprayed or otherwise coated before adding the cast stone composition with from about 4 ounces to about 10 ounces of releasing agent, such as form oil, to facilitate removal of the cast stone product from the mold once it dries.

Once it is removed, the decorative feature can be cured and attached to the desired surface by any suitable attachment means. Screws or the like, or lathe and mortar, can be used for attaching a side of the decorative feature to the wall or other surface. The decorative feature is durable and does not have a tendency to crumble over time or loosen from the surface once it is attached. Decorative features made from the cast stone composition of the present invention are attractive and unlikely to discolor over time. The cast stone composition of the present invention easily conforms to features cut into the molds, even relatively fine features like swirls. Using the present invention, decorative features can be made on-site, where they can be fitted and affixed to the particular exterior or interior surface. If desired, the dry mixture of step (a) can even be transported to the job site, where the remaining steps, (b) through (c), are conducted. A fire retardant, corrosion resistant. water-proof, durable, extra-light cast stone material is made by this method.

The foam beads, stucco mix, white cement, fiberglass fiber, acrylic bonding primer, and water are preferably mixed in a mortar mixer. Preferably, the Portland cement is white Portland cement, the foam beads are Permalite foam beads, and the cementitious material is stucco mix that includes oval and linear fiberglass fibers in a ratio of between about 1:6 and 6:1.

The method preferably further includes the step of mixing a colorant into the dry mixture in step (a), or the wet mixture in step (c). Preferably, step (a) further includes mixing in less than about 15% of fiberglass fiber in the dry mixer, and step (c) comprises mixing from about 5 to about 50% of water into the wet mixture.

The addition of the water according to the method of the present invention (step c following step b) is believed to be important in that it imparts a hard, durable outer layer to the cured cast stone composition, making it particularly well-suited for outdoor use. Decorative features made from the cured cast stone composition have been found herein to be relatively impermeable to water. The present cast stone composition is best used as a decorative feature rather than as a structural feature for supporting weight. For example, the present cast stone composition is effective for use in forming an attractive, durable decorative hand rail around a false balcony, but not as a protective hand rail around a balcony to be used for supporting people.

Step (c) preferably further comprises the steps of:
(i) turning the wet mixture out of the mixer into at least one mold;
(ii) allowing the wet mixture to cure in the mold or molds for at least 12 hours, and preferably between about 24 and about 48 hours, forming the lightweight cast stone product;
(iii) removing the lightweight cast stone product from at least one mold; and
(iv) allowing the lightweight cast stone product to cure in the air for several weeks, most preferably about 14 days. Preferably, step (c)(i) further comprises the step of spraying the at least one mold beforehand with from about 4 ounces to about 10 ounces of a releasing agent; and step (c)(ii) further comprises the step of: adding a plurality of fiberglass rebar sections to the cast stone composition in the mold or molds prior to its hardening. The method of making the lightweight cast stone product preferably includes mixing a colorant into the dry mixture or the wet mixture. For best results, mixing and curing should be done with an ambient temperature of more than about 50 degrees Fahrenheit.

An appropriate amount of the dry ingredients described hereinabove may be bagged and purchased by consumers as a kit. The consumer, who may be a building contractor, adds the prescribed amount of water, and stirs the cast stone composition. Mixing can be done in the bag, if desired. The kit may also include a pouch of pre-measured acrylic bonding primer, which may also be mixed into the composition. The consumer than pours the composition into a pre-made mold and waits about a day for it to dry, and then two weeks for it to cure before attaching it to the desired hard surface. A design for the desired decorative feature has been cut into the mold, which is preferably provided along with the bagged dry ingredients in the kit. The prescribed decorative feature can thus be created on-site.

Decorative features made with the compositions herein include exterior door and window surrounds, key stones, wall caps, pier caps, water table details, or balustrades for exterior attachment, and hand rails, columns, fireplace mantels, or range oven surrounds for attachment to a hard surface in interior of the building. These decorative features can be fabricated to resemble limestone or distressed stone.

The present cast stone composition is intended for use in fashioning decorative features, and not for building walls or as an insulation material. No additional ingredients, such as perlite, a mineral material, are necessary in the present composition. Sand is not an ingredient of the composition of the present invention. The present composition is not a foaming insulation material, and does not include air-entraining or foaming ingredients. Products made from the present composition are lightweight even though they are not hollow.

The following examples demonstrate different embodiments of the lightweight cast stone composition, and method for making the lightweight cast stone product of the present invention. These examples are intended to further illustrate the invention and facilitate its understanding. These examples are given solely for the purposes of illustration and are not to be construed as limiting the present invention in any way.

### EXAMPLE I

The following ingredients are added to an eight horsepower (8 HP) mortar mixer: 14 gallons of Permalite (foam beads); 3.5 gallons of stucco mix with oval and linear fibers; 2 gallons of white Portland cement; and 6 pints of fiberglass fiber. The mixer is turned on and the dry ingredients are thoroughly mixed to form a dry mixture.

Next, 1.75 gallons of acrylic bonding primer is added to the same mixer and thoroughly mixed into the dry mixture to form a wet mixture. Lastly, 3 gallons of water are added to the mixer and thoroughly mixed into the wet mixture to form the lightweight cast stone composition.

This wet mixture is poured into a one cubic yard (1 yd³) cement tray, and transferred from the cement tray into a series of wooden molds and a one cubic foot (1 ft³) wooden mold. The molds are sprayed with a releasing agent prior to the addition of the wet mixture. Then the wet mixture is allowed to cure within the molds for approximately 48 hours. The cured cast stone composition is removed from the molds, weighed, and allowed to cure in ambient air for three (3) weeks. After curing for three weeks, the density of the lightweight cast stone composition is approximately 29 pounds per cubic foot (lbs/ft³).

After curing, individual samples of this cured lightweight cast stone composition are struck with a 26 ounce hammer, thrown on the ground, heated with a soldering torch, left in a swimming pool for several days, or stored for several weeks in a freezer. Results: the samples did not crack, chip, break catch fire, or succumb to water intrusion.

The cured lightweight cast stone formed by this formula is fire-retardant, water-resistant, buoyant, and resistant to the effects of weather (e.g. rain and freezing temperatures). When exposed to water for several days, no water damage occurred. When struck with a 26 ounce hammer, this cured cast stone composition does not crack, chip, or break. The cured cast stone composition is easily attached to a variety of surfaces by adhering the feature using zinc lathe or mortar. The cured cast stone composition is easily cut with a laser or wood saw.

### EXAMPLE II

The following ingredients are added to an eight horsepower (8 HP) mortar mixer: 14 gallons of Permalite (foam beads), 3 gallons of stucco mix with oval and linear fibers, and 1.5 gallons of white Portland cement. The mixer is started and these dry ingredients are thoroughly mixed to form a dry mixture. One pound of a tan powdered colorant is mixed in the mixture.

Next, 1.5 gallons of acrylic bonding primer is added to the same mixer and thoroughly mixed into the dry mixture to form a wet mixture. Lastly, 3 gallons of water is added to the same mixer and thoroughly mixed into the wet mixture.

The wet mixture is poured into a one cubic yard (1 yd³) cement tray, and transferred from the cement tray into a series of wooden molds and a one cubic foot (1 ft³) wooden mold. The inside of the mold is sprayed with form oil before the mixture is added. Then the mixture is allowed to cure within the molds for approximately 48 hours, forming a lightweight cast stone composition suitable for fashioning decorative features. The cast stone composition is removed from the molds, and allowed to cure in the air for three weeks. Decorative features made from the cured cast stone composition according to this example are very light in weight.

### EXAMPLE III

The following ingredients are added to an eight horsepower (8 HP) mortar mixer: 14 gallons of Permalite, 4.5 gallons of stucco mix with oval and linear fibers, 4 gallons of white Portland cement, and 1 gallon of fiberglass fiber. These ingredients are thoroughly mixed to form a dry mixture.

Next, 2 gallons of acrylic bonding primer is added to the mixer and thoroughly mixed into the dry mixture to form a wet mixture. Lastly, 4.5 gallons of water is added to the mixer and thoroughly mixed into the wet mixture.

The wet mixture is poured into a one cubic yard (1 yd³) cement tray, and then transferred from the cement tray into a series of wooden molds and a one cubic foot (1 ft³) wooden mold sprayed with form oil. The cast stone composition is allowed to cure within the molds for approximately 48 hours. The cured cast stone composition is removed from the molds, and allowed to air cure for three weeks. Decorative features made according to this formula are very strong, but weigh more than the cast stone composition of the previous two examples.

### EXAMPLE IV

The following ingredients are added to an eight horsepower (8 HP) mortar mixer: 14 gallons of Permalite foam beads, 3.5 gallons of stucco mix with fiberglass fibers, 2 gallons of white Portland cement, and 6 pints of fiberglass fiber. The mixer is turned on and the dry ingredients are thoroughly mixed to form a dry mixture. Lastly, 1.75 gallons of acrylic bonding primer, 3 gallons of water, and 1 pint of a putty colored colorant are added to the mixer and thoroughly mixed in to form the case stone composition.

The cast stone composition is poured into a one cubic yard (1 yd³) cement tray, and then transferred from the cement tray into a fiberglass mold. The mold is sprayed with form oil prior to the addition of the composition. A design has been cut into the mold. Once the mold has been filled, fiberglass rebar that has been cut to a length just under the length of the mold is inserted into the composition in the mold. Excess composition is screed off the top of the mold and discarded. The cast stone composition is allowed to dry within the mold for about a day. The cast stone product is then removed from the mold, and allowed to cure in ambient air for three weeks.

The decorative feature made from this composition is a 15 foot, approximately 7 inch wide, one-piece water table detail. The water table is adhered to the curved front of a house by one man. Lathe and mortar on the back of the water table is used to adhere the decorative feature to the exterior wall of the house below a set of windows. The water table has a putty color that blends in with the color of the exterior wall.

### EXAMPLE V

The following ingredients are added to an eight horsepower (8 HP) mortar mixer: 14 gallons of Permalite foam beads, 3.5 gallons of mortar, 2 gallons of white Portland cement, and 6 pints of fiberglass fiber. The mixer is turned on and the dry ingredients are thoroughly mixed to form a dry mixture. Lastly, 1.75 gallons of acrylic bonding primer, and 3 gallons of water are added to the mixer and thoroughly mixed in to form the case stone composition.

The cast stone composition is poured into a one cubic yard (1 yd³) cement tray, and then transferred from the cement tray into fiberglass molds. The molds are sprayed with form oil prior to the addition of the composition. A design has been cut into each mold. Once the molds have been filled, fiberglass rebar that has been cut to a length just under the length of the mold is inserted into the composition in the mold. Excess composition is screed off the top of the mold and discarded. The cast stone composition is allowed to dry within the mold for about 24 hours. The cast stone product is then removed from the molds, and allowed to cure in ambient air for three weeks. The decorative features made from this cast stone composition are off-white balustrades, which are attached to the front of a house.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal working of these claims, but which in reality do not materially depart from this invention.

It is to be understood that any amounts given herein are illustrative, and are not meant to be limiting. All ratios, parts, percentages, proportions, and other amounts stated herein are on a weight basis, unless otherwise stated herein, or otherwise obvious to one skilled in the art to which the invention pertains.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A moldable cast stone composition for use in making lightweight cast stone decorative features for attachment to a hard surface, the composition comprising:
(a) from about 30 to about 65% of foam beads having an average diameter of between about 1/32 and about ⅛ inch;
(b) from about 10 to about 25% of a cementitious material;
(c) from about 5 to about 20% of a Portland cement;
(d) from about 5 to about 15% of an acrylic bonding primer; and
(e) the balance being water.

2. The composition according to claim 1, wherein the cementitious material is a stucco mix, the stucco mix comprising at least about 2% of fiberglass fibers.

3. The composition according to claim 2, wherein the Portland cement is white Portland cement; and wherein the composition does not comprise any significant amount of sand.

4. The composition according to claim 1, wherein the lightweight cast stone decorative features have a density of between about 27 and about 40 pounds per cubic foot.

5. The composition according to claim 4, further comprising between about 0.5 and about 15% of fiberglass fiber; wherein the cementitious material is mortar.

6. The composition according to claim 3, wherein the amount of foam beads is from about 50 to about 60%, the foam beads having an average diameter of about 1/16 inch.

7. The composition according to claim 4, wherein the cementitious material is from about 10 to about 25% of stucco mix, the stucco mix comprising oval and linear fiberglass fibers in a ratio of between about 1:6 and 6:1 oval fiberglass fibers to linear fiberglass fibers.

8. The composition according to claim 6, wherein the amount of acrylic bonding primer is from about 5 to about 10%.

9. The composition according to claim 8, further comprising from about 0.2 to about 2% of a colorant.

10. The composition according to claim 8, wherein the cast stone decorative features each weigh between about 25 and about 35 pounds per square foot.

11. A method of making a lightweight cast stone product, the method comprising the steps of:
(a) mixing from about 30 to about 65% of foam beads having an average diameter of between about 1/32 and about ⅛ inch; from about 10 to about 25% of cementitious material; and from about 6 to about 20% of Portland cement in a dry mixer to form a dry mixture;
(b) mixing from about 5 to about 15% of an acrylic bonding primer, and water to bring the balance to 100%, into the dry mixture to form a wet mixture; and
(c) turning the wet mixture out of the mixer into at least one mold, and allowing the wet mixture to dry and cure to form the lightweight cast stone decorative feature.

12. The method according to claim 11, wherein the cementitious material is stucco mix comprising oval and linear fiberglass fibers.

13. The method according to claim 11, wherein step (c) further comprises the steps of:
(i) turning the wet mixture out of the mixer into at least one mold;
(ii) allowing the wet mixture to cure in the at least one mold for at least about 12 hours, forming the lightweight cast stone product;
(iii) removing the lightweight cast stone product from the at least one mold; and
(iv) allowing the lightweight cast stone product to cure.

14. The method according to claim 13, wherein the foam beads have an average diameter of between about 1/32 and about ⅛ inch.

15. The method according to claim 11, wherein the decorative feature is an exterior window surround, key stone, wall cap, pier cap, water table detail, or ballustrade.

16. The method according to claim 13, wherein step (c)(i) further comprises the step of spraying the at least one mold prior to adding the composition with from about 4 ounces to about 10 ounces of a releasing agent.

17. The method according to claim 13, wherein step (c)(ii) further comprises the step of: adding a plurality of fiberglass rebar sections to the cast stone composition in the at least one mold prior to its hardening.

18. The method according to claim 11, wherein the cementitious material is mortar, and further comprising from about 2 to about 10% of fiberglass fiber.

19. The method according to claim 17, wherein the decorative feature is an interior hand rail, column, fireplace mantel, or range oven surround.

20. A kit for making lightweight cast stone decorative features, the kit comprising:
(1) a disposable bag comprising: (a) from about 30 to about 65% of foam beads having an average diameter of between about 1/32 and about ⅛ inch; (b) from about 10 to about 25% of a stucco mix comprising at least about 2% of fiberglass fibers; and (c) from about 5 to about 20% of a Portland cement; and
(2) a fiberglass mold comprising a design for the decorative feature.
